(19) United States
(12) Patent Application Publication
(10) Pub. No.: US 2010/0294036 A1
(43) Pub. Date: Nov. 25, 2010

(54) FLOW SENSOR

(75) Inventor: Neil James Dunbar, Victoria (AU)

Correspondence Address: VOLPE AND KOENIG, P.C., UNITED PLAZA, 30 SOUTH 17TH STREET, PHILADELPHIA, PA, 19103, US

(73) Assignee: SAMARAN INTERNATIONAL PTY. LTD., Victoria (AU)

(21) Appl. No.: 12/863,677

(22) PCT Filed: Feb. 5, 2008
(86) PCT No.: PCT/AU2008/000127

§ 371 Date: Jul. 20, 2010

(51) Int. Cl. G01F 23/26

(52) U.S. Cl. 73/304 C; 73/313

(57) ABSTRACT

A method of monitoring the effectiveness of a liquid distribution system having a body arranged to receive liquid from a supply source and at least one distribution line for receiving liquid from the body, includes sensing the rate at which the liquid flows through the body after supply of the liquid to the body from the supply source.

### FIELD OF INVENTION

The present invention relates to a flow sensor for monitoring the effectiveness of a liquid distribution system. In a particular aspect it relates to a method of monitoring the effectiveness of a liquid distribution system having a body arranged to receive liquid from a supply source and at least one distribution line. It also relates to junction pits' incorporating sensors and sewage dispersal systems incorporating junction pits.

### BACKGROUND

There is a need to split the flow of liquids issuing from a holding tank (e.g. injunction pits) into desired proportions. This is a requirement for the proper management of on-site sewage processing systems. For example, as shown in FIG. 1, an on-site sewage processing system 100 collects sewage effluent from sewer pipe 102 in a septic tank 104. After primary treatment in the septic tank 104, on-site sewage effluent is typically directed to junction pits 118, 120 and 122 and then on to absorption trenches 106, 108 and 110 located below the ground. An absorption line 112, 114 and 116 (e.g. a perforated pipe) is located within each of the aggregate filled absorption trenches 106, 108 and 110. Space, terrain and trench length constraints usually require there to be a number of absorption lines 112, 114 and 116 that are spread out in a down slope direction. This arrangement typically allows the sewage effluent to flow to the absorption trenches 106, 108 and 110 under the force of gravity.

On-site sewage is best managed if it is spread out evenly over the absorption trenches 106, 108 and 110, in accordance with the tested soil percolation and designed long-term absorption characteristics of the soil. However, due to historical circumstances, sometimes the absorption trenches 106, 105 and 110 are flooded beyond their designed application rates in a serial fashion. The junction pits 118, 120 and 112 that are typically used in this arrangement are shown in FIG. 2 (as described in Victoria Environmental Protection Agency (EPA), 1996, Code of Practice—Septic Tanks).

The common problem with the arrangement shown in FIG. 2 is that under normal operation, a small number of absorption trenches (e.g. 106 and 108) are flooded beyond their assessed long-term absorption capacity and consequently fail, usually in a premature serial fashion. However, it is often difficult to control and/or adjust the flow of effluent into different absorption trenches. For example, given the small spatial confines of the junction pits typically used in the on-site sewage processing industry, it is very difficult for plumbers and drainers to accurately assess the flow level in the pit, to construct apertures for controlling the flow proportions and outlet levels to and from the junction pit, and to monitor the absorption capacity of the absorption trenches.

Applicant's co-pending international application PCT/AU2006/001318 to some extent deals with some of these problems by providing devices for controlling flow in the pit. However, there is still room for improvement, particularly in relation to monitoring flow rates and absorption capacities.

### SUMMARY

The invention provides in one aspect, a method of monitoring the effectiveness of a liquid distribution system having a body arranged to receive liquid from a supply source and at least one distribution line for receiving liquid from the body, comprising, sensing, the rate at which the liquid flows through the body after supply of the liquid to the body from the supply source.

The sensing of liquid may be carried out by any method known in the art. For example it may be done electrolytically, by a float, by capacitance or by pressure variation.

The method may be applied to an on site sewage processing system comprising a septic tank, one or more junction pits and one or more distribution lines which may be in the form of absorption trenches. For such a system the body in which liquid levels are sensed may comprise the junction pit.

The liquid levels may be sensed by a sensor located in the junction pit. The sensor may be located at a level in the junction pit such that it becomes immersed in the liquid flowing into the junction pit.

The sensor may sense the presence of liquid electrolytically. It may be arranged to sense the presence of liquid in the junction pit at two levels. Hence it may be associated with timing means for timing the time taken for the level of liquid to fall from the higher of the two levels to the lower of the two levels to give a calculation of the rate of liquid flow from the junction pit into the distribution lines.

When the sensed rate of liquid flow falls below a predetermined limit, a warning signal or alert may be activated. The signal may be used to prompt an inspection of the system. It may even be used to trigger automated flow control means associated with the distribution lines to redistribute rates of flow to the distribution lines.

As the sensor readings can vary substantially, depending on variations in rates of supply of liquid to a junction pit as a result of intermittent and changeable sewer usage, the predetermined limit may be based on a calculation derived from multiple sensor readings. Multiple readings may be treated with a regression algorithm to create a graph of efficiency of dispersion of liquid corresponding to the rate of flow from the pit vs time. When the line graph readings intersect a predetermined level of efficiency reduction, a warning signal may be generated. For example, an efficiency reduction of as little as 25% may be sufficient to trigger a warning depending on the circumstances. However in the majority of instances a reduction of efficiency of more than 40%, 50% or greater will probably be more appropriate.

The method of the invention may be applied to on site sewage processing systems comprising a plurality of junction pits arranged in series with each pit feeding one or more distribution lines. A flow sensor may be placed in the uppermost pit, the lowermost pit, in all of the pits or even a selection of them to suit the circumstances of a particular installation.

One or more of the pits may be fitted with a fitting for controlling flow from the pit to a distribution line.

Thus in a particular aspect the invention may also involve using a fitting for controlling the rate of flow of liquid from a body, such as a pit having flow sensing means, to a distribution line, said fitting including:

a body having one or more openings formed through said body, such that, when said liquid defines a level in said conduit, at least one of said openings is at least partially submerged in said liquid so as to define an effective flow aperture relative to said level for controlling the rate of flow of said liquid through said body;

wherein the selective rotation of said body enables adjustment of the size of said effective flow aperture.

Each fitting may be set for a particular flow rate on initial installation of the sewage processing system. Its setting may be altered in response to warning indications from the sensor so as to compensate for reduced efficiency of one or more distribution lines.

The body may include means for coupling said body to an open end of said conduit. Once the body has been rotated to define an effective flow aperture of a selected size, the body may be securely sealed to the conduit so as to reduce movement of the body with respect to the conduit.

The body may include means for adjusting the height of said body relative to said level. The means for height adjustment may include an elbow joint for coupling with said fitting, said elbow joint also for coupling to said conduit.

The openings may define one or more flow control regions, each said region for defining a corresponding said effective flow aperture of different size relative to said level.

The at least one of the regions may define the effective flow aperture for allowing a high rate of flow relative to the rates of flow for other said regions.

It may allow a rate of flow of around 50% of the high rate of flow.

Another of the regions may define an effective flow aperture for allowing a rate of flow of around 33% of the high rate of flow.

Another of the regions may define an effective flow aperture for allowing a rate of flow of around 25% of said high rate of flow.

The flow apertures for the regions may be defined by a single opening.

The openings may define one or more weirs, each weir corresponding to a different region.

Each of the weirs may be substantially V-shaped.

Each of the weirs may include a rounded weir invert portion.

Each of the weirs may include a knife edge.

The fitting may be made of a plastic material, such as PVC, polythene or polypropylene plastics.

The body may be rotatable along a cross-sectional axis of the body.

The conduit may alternatively or additionally include a fitting as described above.

Broadly speaking the fitting may be suitable for coupling to an end portion of a conduit for controlling the rate of flow of liquid in a conduit, the fitting including:

a disc-like body having an opening formed therethrough, said opening being shaped to form one or more respective weirs, such that, when said liquid defines a level in said conduit, at least one of said weirs is at least partially submerged in said liquid so as to define an effective flow aperture relative to said level for controlling the rate of flow of said liquid through said body;

wherein said body is selectively rotatable relative to said conduit to one or more predefined positions, each said position for defining a different said effective flow aperture, wherein said body, in use, is coupled to said conduit in one of said predefined positions.

To control the rate of flow of liquid in a conduit such as a distribution line using a fitting as described above may involve the steps of:

(i) rotating the fitting relative to the conduit to an orientation that allows one of the one or more openings of said fitting to form an effective flow aperture relative to the level of the liquid in said conduit; and

(ii) coupling said fitting to said conduit at said orientation.

The present invention also provides a method for controlling the flow of liquid through a plurality of distribution lines using one or more fittings and sensors as described herein including the steps of:

(i) rotating each said fitting relative to said conduits to orientations that allow said fittings to form effective flow apertures relative to the level of the liquid in each said conduit; and

(ii) coupling each of said fitting to said conduits at orientations; whereby the relative flows of liquid through respective conduits is within a predetermined distribution, as indicated by the sensors.

The settings of the fittings may be altered as and when the sensors indicate that the liquid flows are approaching the limits of the predetermined distribution or have exceeded the limits ie. the flows to the different distribution lines may be altered to compensate for one or more distribution lines reducing in efficiency as indicated by sensors.

The steps of the above methods can be performed in any order, and. are not limited to the order as described above.

The present invention also provides a sewage dispersal system for controlling the flow of sewage through a plurality of conduits using junction pits and sensors as herein described. The junction pits may include fittings as herein described wherein the fittings are coupled to the conduits at predetermined respective orientations, said orientations being defined by rotating each said fitting relative to said conduits to allow said fitting to form effective flow apertures relative to the level of the liquid in each said conduit, so that the relative flows of liquid through respective conduits is in accordance with a predetermined distribution.

The present invention is useful in providing a simple way to monitor the distribution of the flow of liquid in multiple conduits (e.g. extending from a holding tank or junction pit). The present invention is further advantageous by providing in a particular aspect an easier and more economical way to control flow rate and/or flow distribution, in light of the difficult human and environmental constraints presently associated with such a task.

### BRIEF DESCRIPTION OF THE DRAWINGS

A preferred embodiment of the present invention is herein described, by way of example only, with reference to the accompanying drawings, wherein:

FIG. 1 is a diagram of the components of an on-site sewage dispersal system;

FIG. 2 is a cross-sectional view of a junction pit in existing on-site sewage dispersal systems;

FIG. 3 is a front view of a flow control fitting;

FIG. 4 is a cross-sectional view of the flow control fitting;

FIG. 5 is a cross-sectional view of a junction pit in the on-site sewage dispersal system after installation of flow control fittings to the inlet and outlet pipes;

FIG. 6 is a top view of the junction pit shown in FIG. 5;

FIG. 7 is a diagram of the rotation adjustment of the fitting to compensate for pipe level inaccuracy;

FIG. 8 is a cross-sectional view of a junction pit in the on-site sewage dispersal system after installation of flow control fittings and a height adjustment elbow joint to compensate for substantial pipe level inaccuracy,

FIG. 9 is a top view of the junction pit shown in FIG. 8;

FIG. 10 is a diagram of an asymmetrical dispersal system;

FIG. 11 is a diagram of a symmetrical dispersal system;

FIG. 12 is a cut away view of a junction pit and sensor; and

FIG. 13 is a graph interpreting sensor readings.

### DETAILED DESCRIPTION OF THE PREFERRED EMBODIMENT(S)

The various elements identified by numerals in the drawings are listed in the following integer list.

Integer List
100 Sewage dispersal system
104 Septic tank 106 Absorption trench
108 Absorption trench
110 Absorption trench
112 Perforated pipe
114 Perforated pipe
116 Perforated pipe
118 Junction pit
120 Junction pit
122 Junction pit
124 Pipe
126 Pipe
128 Pipe
202 Growing
204 Lid
206 Outlet weir
208 Opening
210 Aggregate fill
212 Base level
300 Fitting
300a Fitting
300b Fitting
302 Body
302a Position
304 Opening
306 Peripheral portion
308 Peripheral portion
310 Peripheral portion
312 Peripheral portion
314 Cross-sectional axis;
316 Invert
318 Invert
320 Invert
322 Invert
324 Apex angle
326 Apex radius
402 Inner flange
404 Body/outer flange
408 Inner length
410 Outer length
700 Outer length
700 Outlet level
702 Outlet level
802 Baffle
902 Bend
1000 Dispersal system
1001 Junction pit
1002 Junction pit
1003 Junction pit
1004 Junction pit
1005 Junction pit
1011 Absorption trench
1012 Absorption trench
1013 Absorption trench
1014 Absorption trench
1015 Absorption trench
1020 Septic tank
1100 Dispersal system
1101 Junction pit
1102 Junction pit
1103 Junction pit
1111 Absorption trench
1112 Absorption trench
1113 Absorption trench
1114 Absorption trench
1115 Absorption trench
1116 Absorption trench
1120 Septic tank
1201 Junction pit
1203 Pipe
1205 Baffle
1207 Open top
1209 Open bottom
1211 Perforated pipe
1213 Fitting
1215 Sensor
1217 Lower detector
1219 Upper detector
1221 Lead

The following describes aspects of the present invention in the context of a specific area of application relating to on-site sewage dispersal systems. However, it is expected that the present invention may be useful in other applications, such as for the monitoring, regulation or adjustment of the flow of liquid in liquid distribution systems in general (e.g. in aquaculture systems).

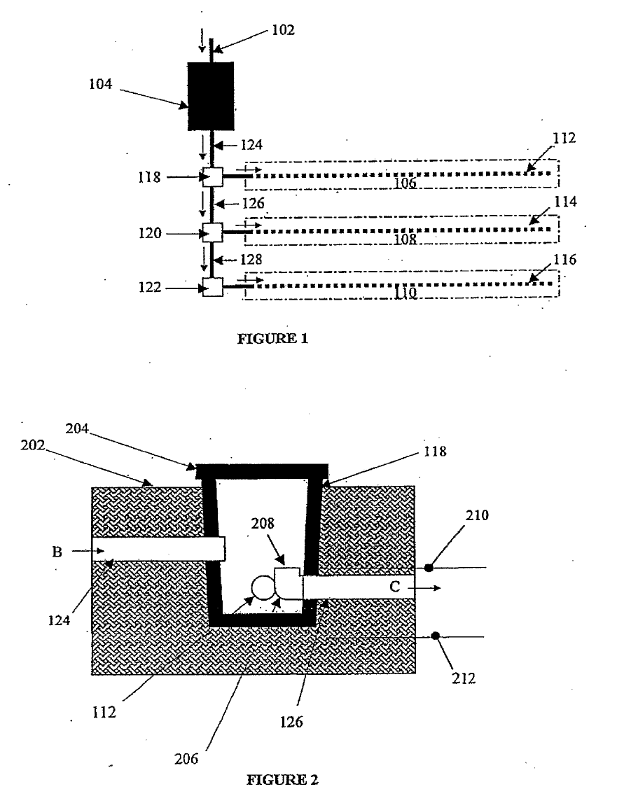

An on-site sewage dispersal system 100, as shown in FIG. 1, includes a septic tank 104 which passes sewage effluent to a number of junction pits 118, 120 and 122 via a series of pipe 124, 126 and 128. Each junction pit 118, 120 and 122 may distribute the effluent into one or more underground absorption trenches 106, 108 and 110 via one or more perforated pipes 112, 114 and 116 located within the trenches. Alternatively, each junction pit (e.g. 118) may distribute the effluent to one or more other junction pits (e.g. 120).

FIG. 2 is a cross-sectional view of a junction pit 118, which is partially buried in the ground 202 and is covered by a lid 204. In a typical configuration, the junction pit 118 receives effluent from the septic tank 104 via an incoming pipe 124 (in a flow direction indicated by arrow B), and then distributes the effluent into an absorption trench 106 via the perforated pipe 112, or to another junction pit 120 via the outlet pipe 126 (in a flow direction indicated by arrow C). The outlet pipe 126 includes a 90° elbow outlet weir 206. The opening 208 of the outlet weir 206 is generally aligned with the top of the aggregate fill 210 inside the absorption trench 106 (accessible via perforated pipe 112). Typically, the base level 212 of the absorption trench 106 is situated about 250 mm below the top of the aggregate fill of the effluent 210 in the absorption trench 106.

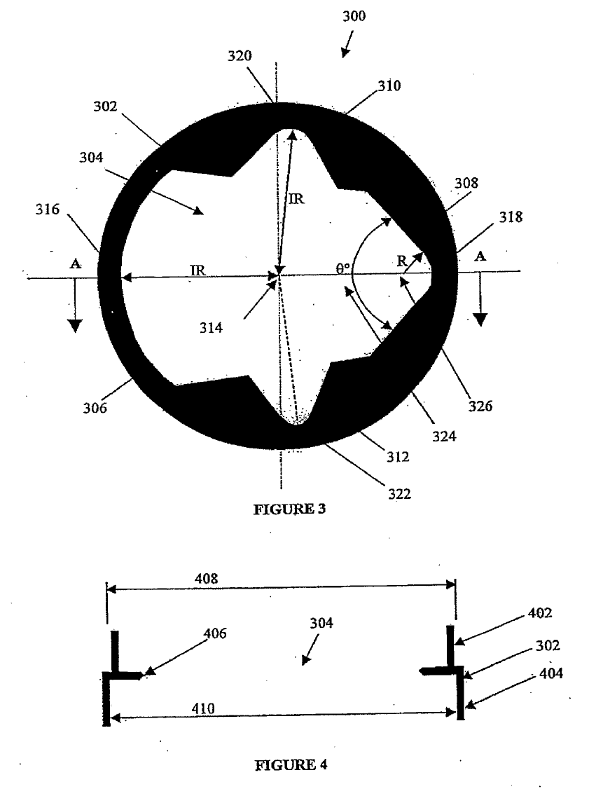

FIG. 3 is a front view of a fitting 300 for controlling the flow of liquid in a conduit. A liquid, as referred to herein, is defined as any composition of matter that, as a whole, is a capable of flowing and is able to conform to the shape of a container or a conduit for carrying the liquid. A liquid includes mixtures that include solid or semisolid matter, such as that typically found in sewage effluent.

As shown in FIG. 3, the fitting 300 includes a body 302 that has one or more openings formed through the body 302. The body 302 may have only one opening 304, and preferably, the edge of the opening 304 is shaped to form multiple weirs. The one or more openings (e.g. 304) define one or more flow control regions of the body 302. For example, in the configuration shown in FIG. 3, the body 302 has only one opening 304, and different peripheral portions 306, 308, 310 and 312 of the opening 304 each respectively defines a different flow control region.

When the fitting 300 is coupled to a conduit (e.g. a pipe), the openings (or a portion of an opening 304) belonging to a particular flow control region defines an effective flow aperture relative to the surface level of the liquid in the conduit to control the flow of the liquid through the fitting 300 at a predetermined rate. This may be achieved in a number of ways. For example, the openings (or a portion of an opening 304) belonging to a flow control region becomes partially submerged in the liquid in the conduit so as to define an effective flow aperture relative to the surface level of the liquid. In this example, the openings (or a portion of an opening 304) act as a wek, which enables the rate at which the liquid flows through the opening(s) to be controlled based on the width, height and/or shape of the opening(s). The flow rate for V-shaped weirs 308, 310, 312, as shown in FIG. 3, may be controlled by adjusting the apex angle 324 and/or the apex radius 326 of the weir. Alternatively, the one or more openings belonging to a flow control region may be sized so as to enable the liquid to flow through the opening(s) at a predetermined rate of flow when the opening(s) are fully submerged in the liquid in the conduit.

Different flow control regions of the fitting 300 enable the liquid to flow through the fitting 300 at different rates of flow. In the configuration shown in FIG. 3, different peripheral portions 306, 308, 310 and 312 of an opening 304 may be arranged about a central cross-sectional axis 314 of the body 302, such that the selective rotational adjustment of the body 302 about the axis 314 enables a different flow adjustment region to be selected for use to control the rate of flow of liquid in the conduit.

For example, the peripheral portion 306 is used to define an effective flow aperture that allows the liquid to flow through the body 302 at a particular rate of flow. When the body 302 is rotated about axis 314 to a different position, a different peripheral portion 308, 310 or 312 is used to define a different effective flow aperture, which respectively allow the liquid to flow through the body 302 at 50%, 33% and 25% of the rate of flow through portion 306. Portion 306 may be shaped as a circular weir, and portions 308, 310 and 312 may each be shaped as a V-notch weir. These flow rates may be typical of initial set-up conditions. After time, one or more of the distribution lines may reduce in efficiency. The settings of the fittings may then be adjusted to rebalance the system.

FIG. 4 is a cross-sectional view of the fitting 300 across section A-A shown in FIG. 3. The inner length 408 corresponds to the inner diameter of a pipe. The outer length 410 corresponds to the outer diameter of a pipe. The fitting 300 includes an inner flange 402 for engaging with an inner portion of a pipe (e.g. 124 or 112) so as to enable the fitting 300 to attach (e.g. by frictional engagement) to the pipe. For example, the inner flange 402 may have a smaller diameter than the body 404 which is effectively an outer flange. This enables the outer facing portion of the inner flange 402 to engage with the inner surface of a pipe (at its open end), thus securing the body 302 to the pipe. The inner flange 402 may have a shape corresponding to the cross-sectional shape of the pipe (e.g. 124 or 112), or alternatively, may include an arrangement of one or more flaps extending from the body 302. The fitting 300 may also include an outer flange 404, which provides directional assistance to the flow of liquid towards or away from the opening(s) 306, 308, 310 and 312. The peripheral edge of each of the openings 306, 308, 310 and 312 may include a knife edge 308, which improves the accuracy of the flow rate proportions controlled by the size of the openings.

Measuring small water flows accurately has traditionally been carried out by the use of knife-edge V-notch weirs, as shown in FIG. 3. In this case the discharge over the weir, represented as parameter Q (units in m³/s), is calculated by Equation 1 (as described in Webber N. B., 1976, Fluid Mechanics for Civil Engineers, Chapman and Hall Ltd):

$$Q = \frac{8}{15} \sqrt{2 g} {C}_{d} tan \frac{θ}{2} {h}_{2}^{\underline{5}} \qquad Equation 1$$

where:

g is the natural gravitation acceleration (typically=9.81 rn/s²)

C_{d} is the weir coefficient (typically 0.585)

θ is the apex angle of V-notch of the weir (see FIG. 3)

h is the discharge head over weir, (m)

Consequently where small flows are concerned, the proportion of flows issuing from the tank are proportional to tan

$$\frac{θ}{2}$$

of the V-notch outlet weir.

In practice, the accuracy of this weir flow equation works best if flow conditions upstream and downstream from the weir are non-turbulent and the weir is not drowned. Consequently, where possible the design of the weir portions 306, 308, 310 and 312, perforated pipe (e.g. 112), outlet pipe (126) and holding tank (e.g. 118) should also be constructed for non-turbulent and non-drowned weir flow conditions. Typically, Equation 1 (or appropriate comparable equations) can be used as an aid for designing a suitable weir system for these conditions.

The provision of a convenient means of flow control by way of a single fitting 300 having one or more openings or functioning as weirs means that multiple proportional flows issuing from a holding tank 118 can be selectively controlled at installation and also during operation. The radial spacing of proportionally shaped/sized weirs at portions 306, 308, 310, 312 allow selective flow control by rotation of the fitting 300. For example, V-notch weirs or curved weirs can be used, provided that the typical accuracy of flow over the weir is within required tolerances (for example, such that the flow the liquid in the conduit is controlled by one of the weirs relative to the level of the liquid in the conduit). Hybrid weir patterns (which incorporate two or more weir curves) or multiple interactive weirs can also be used to control the Tate of flow through the opening(s) of the fitting 300.

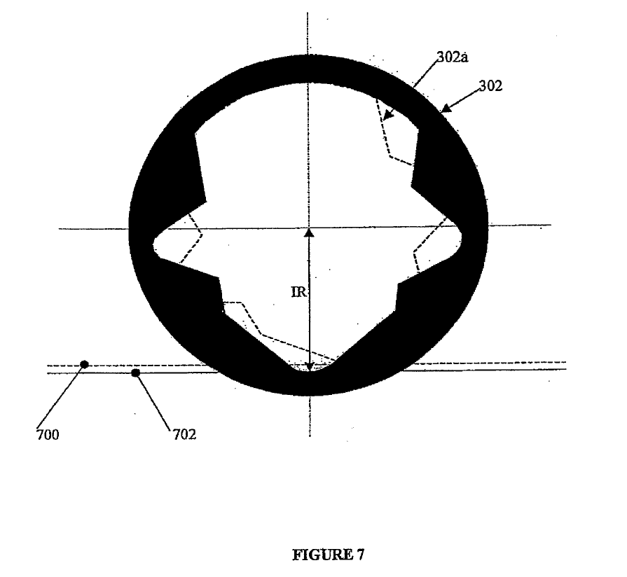

FIG. 3 shows an example of a body 302 including a combination of different proportionally shaped V-notch weirs at portions 306, 308, 310 and 312, each having a curved weir invert. The narrow inverts of the V-notch weirs (as shown in FIGS. 3 and 7) often become clogged with debris in the liquid, which in effect, alters the flow characteristics of the weir. This effect is overcome by constructing a wider circular weir with a small radius (R) in the apex of the V-notch (as shown in FIG. 3). The design of a fitting 300 that includes multiple weir patterns offers a further advantage in that the eccentric nature of the circular arrangement of weirs (see FIG. 3) allows a different weir to be selected for use by rotational adjustment of the fitting 300 relative to the conduit. For example, the incorporation of V-notch weirs allows for small changes of the weir angle by rotation adjustment of the body 302 whilst minimising the effect on the accuracy of the weir at small flows resulting from changes in the weir angle (see FIGS. 3 and 7). The accuracy of the multiple weirs of the fitting 300 may be improved by using small radial weirs (e.g. at portions 308, 310, 312) that also have the same flow rate control proportions as the multiple V-notch weirs at portions 308, 310 and 312. For example, best results (for opportunity of adjustment) may be achieved when the head (or level) of the liquid over the weir is about 10% of the radial invert distance (IR) of the weir (see FIG. 3).

The invert 316, 318, 320 and 322 of each weir at portions 306, 308, 310 and 312 may be arranged equidistant (ie. with the same radial invert distance (IR) from the central cross-sectional axis 314 of the body 302. The weirs at portions 306, 308, 310 and 312 are also spaced sufficiently far enough apart from each other so that different weirs do not interfere with the respective proportional flows. The fitting 300 may have multiple weirs that are radially spaced from each other around the body 302. However, the number of weirs is generally limited by the size of the weir plate and the expected flows over the weirs. Preferably, as shown in FIG. 3, the body 302 includes four weirs at portions 306, 308, 310 and 312.

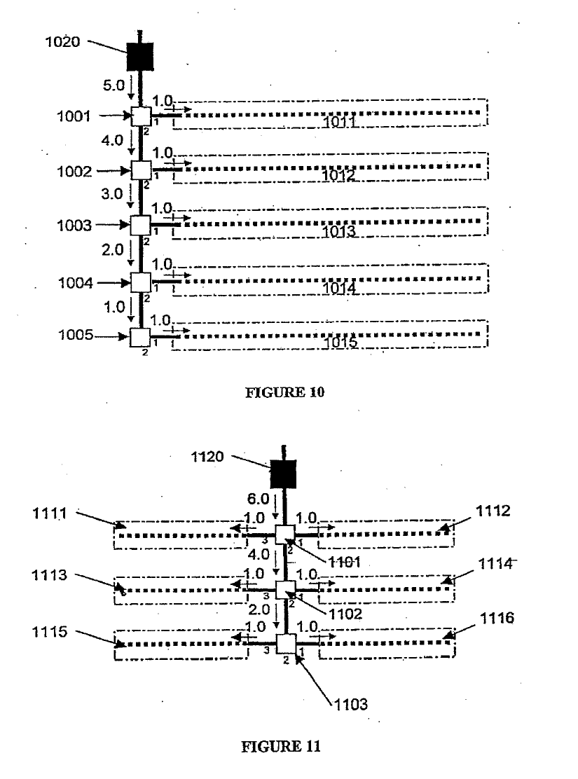

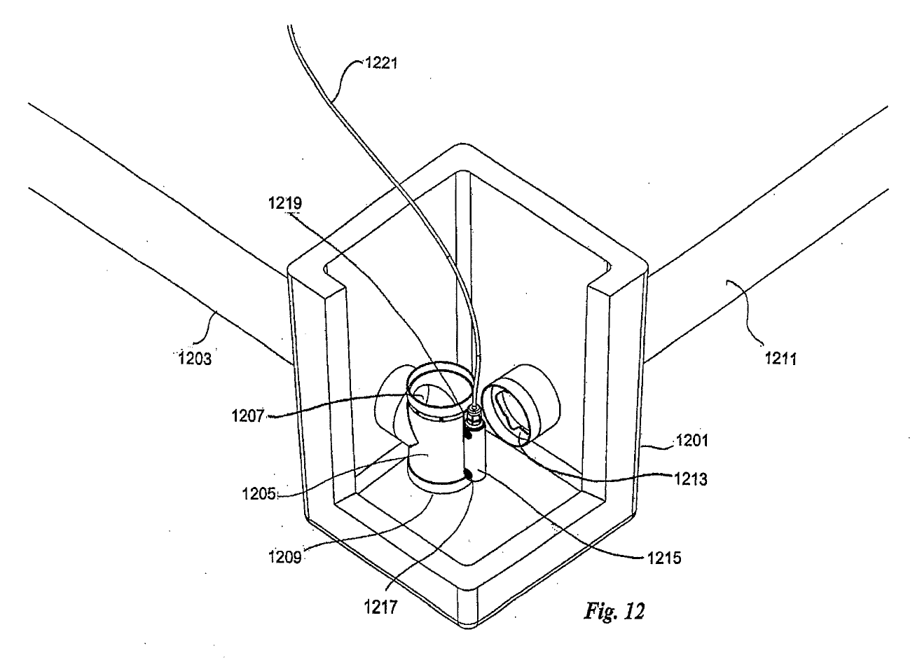

The weirs at portions 306, 308, 310 and 312 are proportionally sized in accordance with the dispersal requirements of the liquid flow downstream from the holding tank (e.g. 118). A preferred dispersal arrangement is to have a series of holding tanks (e.g. junction pits) 118, 120 and 122 which in turn distribute the liquid from a source (e.g. septic tank 104) either to a storage area 106, 108, 110 for its intended use, or to another holding tank 120 and 122 for another serial distribution of liquid, and so on. As the efficiency of the different distribution lines reduces over time, it is possible to vary flow rates from the junction pits to rebalance the system. Hence the need to monitor flow rates as will be described hereinafter. Other dispersal arrangements are possible, as shown in FIGS. 10 and 11.

FIG. 10 is a block diagram of a dispersal system 1000 in an asymmetrical dispersal configuration. The system 1000 distributes effluent from a septic tank 1020 to each of the junction pits 1001, 1002, 1003, 1004 and 1005 in a sequential manner. Each junction pit 1001, 1002, 1003, 1004 ad 1005 has at least one outlet for directing incoming effluent into a corresponding absorption trench (e.g. either 1011, 1012, 1013, 1014, 1015). Some of the junction pits (e.g. 1001, 1002, 1003 and 10043) have a second outlet for directing incoming effluent to another junction pit (e.g. junction pit 1001 has an outlet to junction pit 1002).

FIG. 11 is a block diagram of a dispersal system 1100 in a symmetrical dispersal configuration. The system 1100 distributes effluent from a septic tank 1120 to each of the junction pits 1101, 1102 and 1103 in a sequential manner. Each junction pit 1101, 1102 and 1103 has at least two outlets, each for directing incoming effluent to a different absorption trench (e.g. to 1111, 1112, 1113, 1114, or 1115 and 1116). For example, junction 1101 directs effluent to absorption trenches 1111 and 1112. Some of the junction pits (e.g. 1101 and 1102) have a third outlet for directing incoming effluent to another junction pit (e.g. junction pit 1101 has an outlet to junction pit 1102).

In this circumstance, the weir proportions, expressed as a percentage (%) of maximum weir flow from each holding tank, are estimated using Equation 2 that describes the proportional weir size on each outlet pipe (identified by a number from 1 to n, where n is an integer) for each holding tank.

$$Proportion weir size = \frac{{f}_{1}}{{f}_{m}} \times 100 , \\ \frac{{f}_{2}}{{f}_{m}} \times 100 , \frac{{f}_{3}}{{f}_{m}} \times 100 , … \frac{{f}_{n}}{{f}_{m}} \times 100 \qquad Equation 2$$

where:

fₙ=relative flow of liquid in the nth outlet pipe from holding tank (n is an integer).

fₘ=relative maximum flow of liquid into the holding tank.

With reference to FIG. 10, it is desirable to achieve an even distribution of effluent from the septic tank 1020 into the different absorption trenches 1011, 1012, 1013, 1014 and 1015. Thus, assuming the maximum relative flow from the septic tank 1020 is 5 units, and that each junction pit 1001, 1002, 1003, 1004 and 1005 distributes 1 unit of the maximum relative flow to a corresponding absorption trench, the distribution ratio for each junction pit is as shown in Table 1.

TABLE 1

| Item | Outlet 1 | Outlet 2 | Remarks |
|---|---|---|---|
| Junction pit 1001 | 25 | 100 | fₙ = 1.0, fₘ = 4.0 |
| Junction pit 1002 | 33 | 100 | fₙ = 1.0, fₘ = 3.0 |
| Junction pit 1003 | 50 | 100 | fₙ = 1.0, fₘ = 2.0 |
| Junction pit 1004 | 100 | 100 | fₙ = 1.0, fₘ = 1.0 |
| Junction pit 1005 | 100 | — | Incoming flow is directed to the |
| | | | trench 1015 in full |

With reference to FIG. 11, it is desirable to achieve an even distribution of effluent from the septic tank 1120 into the different absorption trenches 1111, 1112, 1113, 1114, 1115 and 1116. Thus, assuming the maximum relative flow from the septic tank 1020 is 6 units, and that each junction pit 1101, 1102 and 1103 distributes 1 unit of the maximum relative flow to a corresponding absorption trench, the distribution ratio for each junction pit is as shown in Table 2.

TABLE 2

| Item | Outlet 1 | Outlet 2 | Outlet 3 | Remarks |
|---|---|---|---|---|
| Junction pit 1101 | 25 | 100 | 25 | fₙ = 1.0, fₘ = 4.0 |
| Junction pit 1102 | 50 | 100 | 50 | fₙ = 1.0, fₘ = 2.0 |
| Junction pit 1103 | 100 | — | 100 | fₙ = 1.0, fₘ = 1.0 |

From Tables 1 and 2, it can be see that four distribution ratios are commonly used to achieve the dispersal requirements in each dispersal systems 1000 and 1100 as shown in FIGS. 10 and 11. The four distribution ratios permit liquid to flow through at about 100%, 50%, 33% and 25% of the maximum relative flow into each junction pit. The fitting 300 shown in FIG. 3 enables different distribution ratios to be achieved by having different flow control portions, where at least one of the flow control portions allows a flow rate of approximate 100% (e. this is the maximum flow rate proportion issuing from the holding tank, over any time interval), and the preferably the fitting 300 has other flow control portions for allowing a maximum flow rate proportion of approximately 50%, 33% and 25% (relative to the flow control portion allowing a flow rate of about 100%). However, a fitting 300 may have any number of flow control portions, each for allowing a different rate of flow as required.

After the appropriate proportional weir has been chosen from Tables 1 and 2, the fitting 300 is simply slotted into or onto the stub-end of the outlet pipe. The fitting 300 is then rotated so that the invert 316, 318, 320 and 322 of the appropriate proportional weir at portions 306, 308, 310 and 312 is level with the holding tank's ideal common weir outlet level 702 (as shown in FIG. 7). In each holding tank, the common weir outlet level 700 is determined by filling the holding tank with liquid (e.g. tap water) to a common weir outlet level.

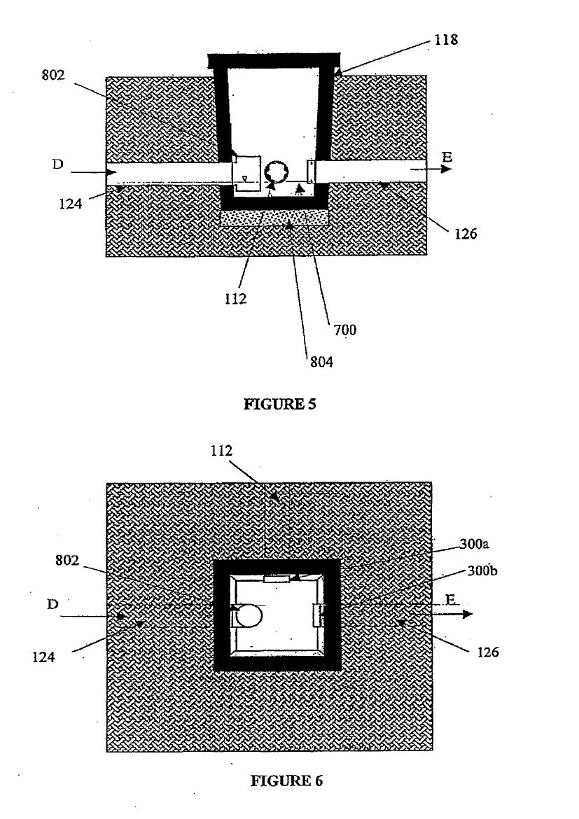

FIG. 5 is a cross-sectional view of a junction pit 118 in the on-site sewage dispersal system after installation of flow control fittings to the inlet and outlet pipes, and FIG. 6 is a top view of the same junction pit 118. As shown in FIG. 5, a drowned end of the pipe baffle 802 is positioned below the surface of the common weir outlet level 700. The flow direction of liquid into and out of the junction pit 118 is indicated by flow arrows D and E respectively. The end portions of the pipes 112 and 126 are fitted with a respective flow control fitting 300am and 300b. The rotational adjustment of each flow control fitting 300 controls the flow in the pipes 112 and 126. For example, the fitting 300 attached to pipe 126 may be adjusted to allow a predetermined flow rate, while the fitting 300 attached to pipe 112 may be adjusted to allow liquid to flow through at 50% of the predetermined flow rate.

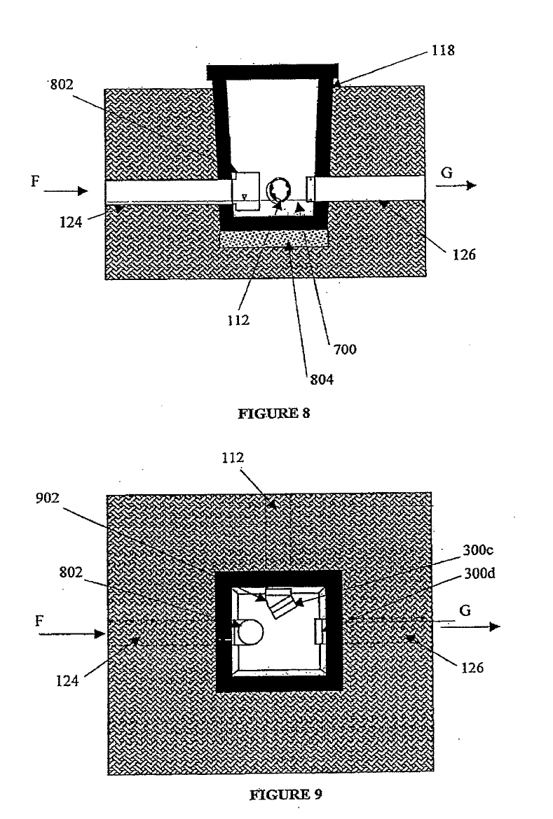

FIGS. 8 and 9 show a cross-sectional view and top view of a junction pit 118 in a similar configuration to that shown in FIGS. 5 and 6. The flow direction of liquid into and out of the junction pit 118 is indicated by flow arrows F and G respectively. The end portions of the pipes 112 and 126 are fitted with a respective flow control fitting 300c and 300d. As shown in FIG. 9, the flow control fitting 300 is fitting to an appropriate pipe bend 902 (or elbow joint).

When constructing the holding tank with multiple pipe outlets, the fitting 300 will give best results if the outlet pipes are of a common size and exit from the holding tank with the same invert level. However, this may be difficult to achieve in practice. As shown in FIG. 7, the common weir outlet level 700 may be different to the ideal common weir outlet level 702 due to pipe level inaccuracy during construction/installation. The fitting 300 therefore allows easy adjustment in common weir outlet level of about 10% of the radial invert distance (ER) for the weirs at portions 306, 308, 310 and 312 (see FIG. 7). For example, as shown in FIG. 7, the original position of the body 302 is shown in solid lines, and the body 302 is adjustable by rotation to a second position 302a as shown in dotted lines. Beyond this level of adjustment, more radical level adjustment measures are required. A typical radical measure involves installing an appropriate pipe bend 902 (e.g. a suitable pipe elbow joint) and coupling the fitting 300 onto the appropriate outlet pipe stub end (see FIGS. 8 and 9). The pipe bend 902 and weir end-cap is typically located on the outlet pipe (or pipes) with the lowest invert level. Pipe bends 902 with larger deflection angles will also accommodate greater levels of adjustment This arrangement is also suitable for retrofitting suitable junction pits.

If the holding tank is small and is constantly or intermittently filled from an exterior source, then a pipe baffle 802 (e.g. a pipe T joint) is installed on the stub end of the inlet pipe to the holding tank (see FIGS. 5, 6, 8 and 9). The use of a pipe baffle 802 will help to dissipate the directional energy of the inlet flow, and promote more accurate flows of water over the proportional outlet weirs at portions 306, 308, 310 and 312.

The fitting 300 may be made from the materials that are commonly used in the plumbing industry, including PVC, polythene, or polypropylene plastics. The fitting 300 may be mass-produced using an injection moulding process. The wells at portions 306, 308, 310 and 312 of the fitting 300 can be designed so that it can be fitted into or onto a standard pipe fitting with a water-tight joint (e.g. resulting from the engagement between the inner flange 402 with the inner portion of the pipe, as shown in FIG. 4). In the onsite wastewater management industry, 90 mm diameter PVC stormwater pipes are commonly used to move sewage effluent from the septic tank to the absorption trenches.

The flow control fittings in association with flow control sensors may be used to appropriately split and proportion liquid flows issuing from a storage holding tank as and when necessary. This is a common requirement of the onsite sewage management industry. However, the present invention may also be used in other industries such as the aquaculture industry. As an example, the present invention is useful for controlling the flow of liquid in a conduit, where the depth of the liquid does not exceed the depth of the proportional weirs at portions 306, 308, 310 and 312 (ie. the respective ideal common weir outlet level for each weir at portions 306, 308, 310 and 312) in the fitting 300. The flow capacity of each weir can be estimated from Equation 1. The accuracy of the weir flow is typically less than 5% of the estimated flow. The weir system works best if the flow of fluid over the weir is non-turbulent and the weir is not drowned.

Referring to FIG. 12 there is shown a junction pit 1201 which may be used in any of the sewage dispersal systems of the type already described hereinbefore.

The junction pit receives sewage for treatment via a pipe 1203 which terminates in a baffle 1205 located within the junction pit.

The baffle has an open top and an open bottom as has been described hereinbefore. Similarly, a perforated pipe 1211 directs water from the junction pit to underground absorption trenches.

A fitting 1213 of the type described hereinbefore is used to control the flow of water into the perforated pipe.

A sensor 1215 is located within the junction pit at a level where it can sense the presence of different levels of liquid in the junction pit. Typically, the sensor may be mounted on the baffle 1205 although other alternative methods of mounting are possible.

The sensor has a lead 1221 which directs signals to a monitoring station to give readings of changes of liquid levels in the junction pit. For this purpose, the sensor has a lower detector 1217 and an upper detector 1219. Typically, the upper and lower detectors may comprise electrolytic detectors ie. they may sense the presence of liquid at the level of the detector by the presence or absence of current flowing between electrodes in each of the detectors.

Thus, by determining the presence or absence of liquid at the levels of the two detectors and the time taken for the liquid level to fall the distance between the two detectors, it is possible to obtain an indication of the rate at which liquid flows from the junction pit into the distribution lines associated with the perforated pipe 1211 and onward to any further junction pits in the sewage dispersal system.

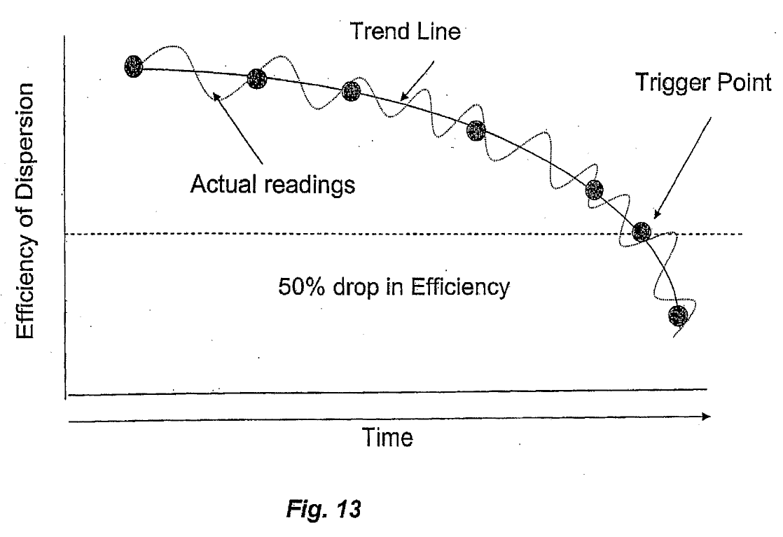

Referring to FIG. 13, it can be seen that a typical range of readings from the sensor is shown by the dotted line marked “Actual Readings”. The readings may typically oscillate about a trend line calculated as a regression algorithm to create a line of best fit. The variation in the actual readings will typically reflect different rates of sewage delivery over time as well as different rates of distribution of effluent in the underground absorption trenches. These rates may vary depending on a range of factors such as rainfall in the area, variation in the amount of effluent distributed and the efficiency of the absorption trench.

Once the overall efficiency over a period of time as determined by the trend line has dropped below a predetermined level e.g. 50%, a trigger point is reached and a monitor receiving signals from the sensor may give a warning indication that the system needs to be inspected. As a result of inspection, it may prove necessary to extend the dispersal system to cope with the reduction in efficiency, to completely replace the system, to reconfigure the distribution of effluent through the various absorption trenches by altering the settings of the fittings 1213 or any combination of these alternatives.

The present invention works effectively when the storage holding tank (e.g. 118) is constructed in accordance with the following preferred features:

(i) it is unlikely to move on its foundations (e.g. on a sand foundation bed to minimize ongoing settlement of the junction pit 118, as shown in FIGS. 5 and 8);

(ii) the outlet pipes and holding tank are of sufficient size to promote non-turbulent and non-drowned flow over the weirs (at portions 306, 308, 310 and 312);

(iii) the outlet pipes communicating with a particular holding tank (e.g. 118) have the same diameter, and that fits onto/into the fitting 300;

(iv) the outlet pipes communicating with a particular holding tank (e.g. 118) have the same invert level (e.g. 322);

(v) the outlet pipes communicating with a particular holding tank (e.g. 118) have a stub-end that protrudes a sufficient distance into the holding tank (e.g. 118) for the fitting 300 to be slotted onto/into the stub end of the pipe;

(vi) the inlet pipe to the holding tank (e.g. 118) has a T-section baffle 802 (see FIGS. 5, 6, 8 and 9); and

(vii) the desired proportion of flows issuing from a particular holding tank (e.g. 118) match the weirs provided by the fitting 300 at each outlet pipe from that holding tank (e.g. 118).

Once the above conditions have been achieved the installer, typically a plumber or drainer in the case of the onsite sewage industry, installs the fitting 300 as follows:

Normal Installation Procedure:

1. The contact edge of all fittings 300 are greased for easy rotation adjustment and sealant purposes.

2. The installer connects the leads of the sensors to a central monitor housed remotely from the system.

3. The storage holding tank 118 is typically filled with water or other suitable fluid to the invert level of the outlet pipe (e.g. 122 and 126) with the lowest invert level. If the higher constructed invert levels of the remaining pipes are less than 10% of the IR distance (see FIG. 7) then the installer continues with step 3. If this is not the case for the invert level 702 of any outlet pipe, then the installer goes to the Radical Installation Procedure (as described below).

4. The installer determines which of the outlet pipes (e.g. 122 and 126) has the highest invert level, and selects the appropriate weir for that outlet pipe (as described with reference to FIGS. 10 and 11).

5. The fitting 300 is then slotted onto/into the stub end of the outlet pipes (e.g. 122 and 126) and rotated so that the invert level of the selected weir is at its lowest possible level. This invert level setting is designated as the common weir outlet level.

6. The installer appropriately selects the weir settings for the remaining outlet pipes (e.g. 122 and 126) and installs the fittings 300 in the normal fashion so that the invert level of the selected weir is rotated to a level expected to be slightly above the common weir outlet level.

7. The installer fills the storage holding tank 118 up to the common weir outlet level and rotates the selected weir invert levels of all remaining fittings 300 down to the common weir outlet level.

8. The installer checks that everything is installed at the right level by running some extra fluid into the storage holding tank via the inlet pipe (e.g. 124). Small adjustments in weir level are made where necessary. The weir distribution system is now ready for use.

Radical Installation Procedure:

1. The contact edge of all fittings 300 and pipe elbow joints 902 are greased for easy rotation adjustment and sealant purposes.

2. The installer connects the leads of the sensors to a central monitor housed remotely from the system.

3. The storage holding tank 118 is typically filled with water or other suitable fluid to the invert level of the outlet pipe (e.g. 122 and 126) with the lowest invert level. If the higher constructed invert levels of the remaining pipes are greater than 10% of the IR distance (see FIG. 7) then the installer continues with step 3. If this is not the case for the invert level of any outlet pipe, then the installer goes to the Normal Installation Procedure (as described above).

4. The installer determines which of the outlet pipes (e.g. 122 and 126) has the highest invert level, and selects the appropriate weir proportions for those outlet pipes (as described with reference to FIGS. 10 and 11).

5. The fitting 300 is then slotted onto/into the stub end of the outlet pipes (e.g. 122 and 126) and rotated so that the invert level of the selected weir is at its lowest possible level. This invert level setting is designated as the common weir outlet level.

6. The installer appropriately selects the weir settings for the outlet pipes (e.g. 122 and 126) with differential invert levels greater than 10% of the IR distance, and if required, installs a pipe elbow bend 902 and fitting 300 on the outlet pipe stub end in the normal fashion (see FIGS. 7 and 8). The elbow joint 902 and fitting 300 are both rotated so that the invert level of the selected weir is expected to be slightly above the common weir outlet level.

7. The installer appropriately selects the weir settings for the remaining outlet pipes (e.g. 122 and 126) with differential invert levels less than 10% of the IR distance and installs fittings 300 on the outlet pipes (e.g. 122 and 126) in the normal fashion so that the invert level of the selected weir is rotated to a level expected, to be slightly above the common weir outlet level for the outlet pipes (e.g. 122 and 126).

8. The installer fills the storage holding tank up to the common weir outlet level and rotates the selected weir invert levels of all remaining weir end-caps and pipe bends where necessary down to the common weir outlet level.

9. The installer checks that everything is installed at the right level by running some extra fluid into the storage holding tank via the inlet pipe (e.g. 124). Small adjustments in weir level are made where necessary. The weir distribution system is now ready for use.

Within the onsite wastewater management industry this present invention is useful in improving the overall performance of a typical septic tank treatment system. The longevity of the treatment system can be increased, and the overall risk to public health and environment can be decreased. Established septic tank systems can also be retrofitted, and thus achieve similar benefits. Consequently, the present invention may provide economic and health advantages to the community.

Many modifications will be apparent to those skilled in the art without departing from the scope of the present invention as herein described with reference to the accompanying drawings.

The reference to any prior art in this specification is not, and should not be taken as, an acknowledgement or any form of suggestion that that prior art forms part of the common general knowledge in Australia.

1. A method of monitoring the effectiveness of a liquid distribution system having a body arranged to receive liquid from a supply source and at least one distribution line for receiving liquid from the body, comprising, sensing the rate at which the liquid flows through the body after supply of the liquid to the body from the supply source.

2. The method according to claim 1, wherein the flow rate of the liquid is sensed by monitoring changes of liquid level in the body over time.

3. The method according to claim 2, wherein the liquid level is sensed electrolytically, by a float, by capacitance or by pressure variation.

4. The method according to claim 1, wherein the liquid is sewage effluent and the liquid distribution system comprises a sewage dispersal system, the body comprises a junction pit, the supply source comprises a conduit for supplying sewage effluent to the junction pit and the distribution line comprises a perforated pipe arranged to allow the sewage effluent to seep into ground along a length of the pipe.

5. The method of claim 4, wherein the supply source comprises a septic tank.

6. The method according to claim 1, comprising generating a warning signal when the sensed rate of liquid flow falls below a predetermined limit.

7. The method according to claim 6, wherein the predetermined limit is at least 25% below a maximum rate of sensed liquid flow calculated as a function of a plurality of liquid flow rates taken from an initial start time.

8. The method according to claim 7, wherein the predetermined limit is at least 40% below the maximum rate of sensed liquid flow.

9. A junction pit for a sewage dispersal system comprising an inlet, an outlet and a sensor adapted to generate an electrical signal which can be used to determine the flow rate of sewage effluent from the junction pit by sensing the rate of change of level of sewage effluent in the junction pit.

10. The junction pit according to claim 9, comprising a warning device arranged to generate a warning signal when the flow rate falls below a predetermined limit.

11. The junction pit according to claim 9, comprising at least two outlets.

12. The junction pit according claim 9, comprising a flow control fitting arranged to control rate of flow of sewage effluent through the outlet or at least one of the outlets.

13. The junction pit according to claim 12, wherein the flow control fitting comprises a body arranged to control the rate of flow of sewage effluent through the outlet by setting the orientation of the body.

14. The junction pit of claim 13, wherein the body comprises openings which define flow control regions, each flow control region defining a corresponding effective flow aperture of different size for a range of levels of sewage effluent in the junction pit.

15. The fitting as claimed in claim 14, wherein at least one of the flow control regions defines an effective flow aperture for allowing a high rate of flow relative to the rate of flow for another of the flow control regions for a range of the levels.

16. The junction pit according to claim 15, wherein the body is disc like and has an opening formed therethrough, the opening being shaped to form one or more respective weirs, such that, when sewage effluent defines a level in the junction pit, at least one of the weirs is at least partially submerged in the sewage effluent so as to define an effective flow aperture relative to the level for controlling the rate of flow of the sewage effluent through the body; and
the body is rotatable relative to the outlet.

17. A sewage dispersal system comprising,
a source of sewage effluent,
at least one junction pit according to claim 9, arranged to receive sewage effluent from the source, and
at least one distribution line arranged to channel the sewage effluent from the junction pit so that it seeps into an area of ground.

18. The sewage dispersal system according to claim 17, comprising a plurality of the junction pits arranged so as to allow sewage effluent to flow from one junction pit to the next in series.

19. The sewage dispersal system according to claim 18, wherein at least one of the junction pits is not fitted with the sensor and at least one of the junction pits is fitted with the sensor.

20-22. (canceled)
